(19) United States
(12) Patent Application Publication
(10) Pub. No.: US 2026/0185888 A1
(43) Pub. Date: Jul. 2, 2026

(54) SENSING ELEMENT COMPOSITIONS AND SENSOR SYSTEM BASED ON 3D CARBON MICROSTRUCTURES FOR DETECTING AND MONITORING STRUCTURES LEAKS SUCH AS HYDROCARBONS

(71) Applicant: Direct-C Limited, Edmonton (CA)

(72) Inventors: Kaushik Parmar, Calgary (CA); Stephen Edmondson, Nobel (CA)

(21) Appl. No.: 19/133,113

(22) PCT Filed: Nov. 27, 2023
(86) PCT No.: PCT/IB2023/061941

§ 371 Date: May 27, 2025

Related U.S. Application Data
(60) Provisional application No. 63/428,034, filed on Nov. 25, 2022.

(51) Int. Cl. G01M 3/16

(52) U.S. Cl. CPC G01M 3/16

(57) ABSTRACT

A sensing element may include a composition comprising 3D chemically connected carbon structures, for example formed of chemically connected nanomaterials, such as, Carbon Nanotubes, Carbon Nanofilaments, Carbon Nanofibers or Graphene Nanoplatelets The structures may be embedded in a polymer. Other particles such as metal oxides may also be incorporated in a polymer. The sensing element that may be applied on to a surface for sensing leakage, of a transportation and/or storage structure including hydrocarbon storage structures. Electrical signals from the sensing element are processed to check for indicators of leakage.

### PRIORITY CLAIM

This application is a U.S. national phase of International Patent Application No. PCT/IB2023/061941 filed Nov. 27, 2023; which claims the benefit of priority from U.S. Provisional Patent Application No. 63/428,034 filed Nov. 25, 2022, the contents of which are incorporated herein by reference.

### FIELD OF THE INVENTION

The disclosed compositions and systems relate to detecting and monitoring leaks of fluids such as hydrocarbons.

### BACKGROUND OF THE INVENTION

It is critical to monitor storage and transportation structures carrying fluids including hydrocarbons for any leaks of failure. Sensing elements that are capable of responding to leaked chemicals/fluid can provide a quick detection of any such leaks. For hydrocarbon oil leaks, there are many such chemiresistive sensors are developed. For example, U.S. Pat. Nos. 11,143,610 and 8,012,420 describe two of such sensor material composition that includes polymer admixed with carbon-based particles. U.S. Pat. No. 8,012,420 teaches the use of “axial geometry” (rod-shaped) particles such as carbon nanotubes, in some embodiments supplemented by carbon black. U.S. Pat. No. 11,143,610 describes the use of carbon nanotubes and graphene. Carbon nanoparticles are shown to be much effective in chemical sensing application due to their high surface area. However, sensing gaseous leaks which depends on adsorption of chemical species is more challenging with embedded Carbon nanoparticles.

References that nonetheless use graphene for gas detection include CN 104569064 and WO 2021057590.

By incorporating metal oxide nanoparticles within the sensing film can improve gas sensing ability of the film. For example, US Publication Nos. 2006/0249384A1 and 2016/0216228A1 propose using metal oxide nanoparticles to promote gas sensing ability.

U.S. Pat. No. 10,908,108 teaches the use of multiple carbon nanostructures arranged on a substrate for gas detection. The requirement that the nanostructures are arranged on a single substrate is believed to be inconvenient for manufacture.

Many compositions that incorporate carbon nanoparticles and metal oxide particles are proposed but they lack in providing formulation which can provide wide range in sensing gas and liquids. If carbon nanoparticles are chemically interconnected to make microstructures and incorporated in such sensing application, they have the potential to provide outstanding sensing properties. Ozden et al. has shown that 3D microstructure formed from chemically cross-linked carbon nanotubes shows higher gas adsorption compared to network of carbon nanotubes. However, the affect of such adsorption on the electrical properties of the microstructures is not known in the prior art to the inventors' knowledge.

U.S. Pat. No. 5,498,372 discloses that carbon black particles may change conductivity when exposed to hydrocarbons, but does not teach the use of such particles to form a sensor. Rather, U.S. Pat. No. 5,498,372 teaches suppressing these changes using a conductive coating of the particles.

Further enhancing the sensitivity of the sensor film, particularly to gases, is desirable.

### SUMMARY OF THE INVENTION

There is provided in one embodiment a sensor for monitoring fluid leakage in a transportation or storage structure. The sensor may comprise a data acquisition system in communication with electrodes connected to measure an electrical property of a composition. The composition may include a polymer; and, embedded within the polymer, conductive or semi conductive carbon particles having chemically connected 3D structure. In various embodiments there may be included any one or more of the following features. The particles may have a specific surface area, measured by N₂ absorption, of at least 100 m²/g. The composition may include dispersed carbon nanomaterials in addition to the particles having 3D carbon structures. One or both of the particles having 3D carbon structures and the dispersed carbon nanomaterials have surfaces having functional groups. The composition may also include semiconductive metal oxide nanoparticles, either included in the particles having 3D carbon structures or separately dispersed within the polymer. The semiconductive metal oxide nanoparticles comprise Iron Oxide, Tin Oxide, or Zinc Oxide. The polymer may be one or more of: (i) synthetic rubber, (ii) polyvinyl chloride, (iii) polymethacrylate, (iv) silicone-based polymer; and (v) thermoplastic polymer. The polymer may be a polysiloxane copolymer. The sensor may be for monitoring leakage of a hydrocarbon fluid. The conductive and/or semi conductive particles having 3D carbon structures may be locally crystalline carbon nanotube networks. The 3D carbon structures may include locally crystalline conductive or semi conductive microstructures comprising networks of chemically connected one or a combination of: (i) Carbon Nanotubes, (ii) Carbon Nanofibers, (iii) Carbon nanofilaments, and (iv) Graphene platelets. The 3D carbon structures may be 3D nanostructure graphene sponges.

There is provided in another embodiment a sensor system for monitoring leakage in a transportation or storage structure. The sensor system may include one or more sensing elements, each sensing element comprising a polymer and particles comprising 3D carbon structures of chemically connected carbon embedded in the polymer. Each sensing element may have a positive electrode and a passive electrode, the passive electrode being connected to ground; and the sensor system further may also include a data acquisition system in communication with the positive electrode of each sensing element, for receiving electrical signals from the one or more sensing elements. In various embodiments there may be included any one or more of features of the above disclosed embodiments, and/or any one or more of the following features. The polymer may be arranged as a sheet having a thickness direction, the sensor system including a sensing element which measures an electrical property in the thickness direction in addition to one which measures the electrical property parallel to the sheet. The polymer may be a polysiloxane. The electrodes may comprise one or more of: silver, copper, gold, and platinum. The one or more sensing element is apply-able directly on to at least a portion of the transportation or storage structure. The sensor system may include a substrate wherein the one or more sensing element is disposed on to the substrate, and the substrate is installable on at least a portion of the hydrocarbon transportation or storage structure. The substrate may include one or more of: polyimide, polyethylene terephthalate (PET), polycarbonate (PC), and fluorene polyester polyimide, PEEK. A current limiting resistance may be applied to each sensing element. The current limiting resistance may be varied across the one or more sensing elements to provide a unique representative voltage to at least one of the one or more sensing elements. An analog electrode tagging process may be used to locate the at least one sensing element. The data acquisition system may comprise a multiplexer microswitch which switches between electrodes of different sensing elements. The multiplexer microswitch may be controlled by a microcontroller clock establishing a frequency for the switching from one electrode to another. There may be a de-multiplexer system for de-multiplexing signals output by the multiplexer microswitch, and wherein the de-multiplexed signals are processed using an ANFIS algorithm. The system may be calibrated to take into account temperature effects on the sensor network.

### BRIEF DESCRIPTION OF THE DRAWINGS

Embodiments will now be described with reference to the figures, in which like reference characters denote like elements, by way of example, and in which:

FIG. 1 is a schematic diagram showing components of an exemplary sensor element.

FIG. 2 is a schematic diagram of a voltage drop circuit usable for processing electrical signals from the sensor system of FIG. 1.

FIG. 3 is an isometric view of an embodiment of a structure of carbon x locally crystalline carbon structure.

FIG. 4 is a top view of an embodiment of an uncoated 25×15 mm rectangular sensor substrate.

FIG. 5 is a top view of an embodiment of a coated 25×15 mm rectangular sensor.

FIG. 6 is a back view of an embodiment of a coated 10 mm circular sensor showing electrode pattern. Dark spots visible in this figure are believed to by specks of coating that came around the sensor when sprayed on the front.

FIG. 7 is a front view of an embodiment of a coated 10 mm circular sensor.

FIG. 8 is a graph showing % increase in resistance vs temperature of a coating containing a 3D Carbon microstructure.

### DETAILED DESCRIPTION OF THE PREFERRED EMBODIMENT

There is provided in one embodiment a sensor film for detecting and monitoring structure leaks for detecting one or more chemical fluids comprising a polymer matrix admixed with 3D conductive or semi-conductive Carbon microstructure and/or metal oxide nanoparticles. 3D conductive or semi-conductive carbon microstructure comprises of chemically connected one or more of carbon nanostructures such as carbon nanotubes, carbon nanofibers, carbon nanofilaments and Graphene nanoplatelets. The term “3D structure” here refers to a chemically bonded structure including significant internal porosity with pore size at a scale small relative to the external dimensions of the structure. For example, a pore size may be between 5 nm and 100 nm, and the external dimensions may be between 10 and 1000 times the pore size. The 3D structures may be crystalline at a nano scale, for example, being formed of locally crystalline nanotubes.

The sensors may be constructed for example as disclosed in U.S. Pat. No. 11,143,610 but with sensing compositions according to the disclosures in this document. For example, where U.S. Pat. No. 11,143,610 discloses loose carbon nanotubes (CNTs) or graphene nanoplatelets (GNPs), a sensor according to the present disclosure may include CNT microstructures or other particles having 3D carbon structure and adequate porosity. A sensor may include an Internet of Things (IOT) unit interrogating one or more sensor elements. Additional disclosure in this document regarding the sensor construction may be considered as improvements relative to the sensor constructions disclosed in U.S. Pat. No. 11,143,610.

The chemical bonding of the CNT microstructures provides a higher strength unified structure as compared to loose CNTs. Loose CNTs are known to get broken during mixing due to shearing or agglomerate creating physically weaker material. The unified structure is also porous (not filled with polymer) that allows gases to get adsorbed on its surface. The Ozden reference studies this behavior empirically showing gas adsorption in chemically bonded CNT structure is higher than loose CNT networks. So, leaking fluid interacts with the sensor surface comprising chemically bonded structures that have high gas adsorption capability.

As fluids enter the sensor, resistance can be caused by interaction with the polymer and interaction with the particles within the polymer. For example, chemicals may be absorbed into the polymer causing swelling of the polymer which moves the microstructures apart increasing overall resistance, or chemicals may be adsorbed onto CNTs within the microstructures increasing their resistance. It is believed that the former mechanism is predominant with liquids and the latter predominant with gases, given a typical composition as disclosed in this document.

Several experiments are performed to showcase the abilities of the presented invention.

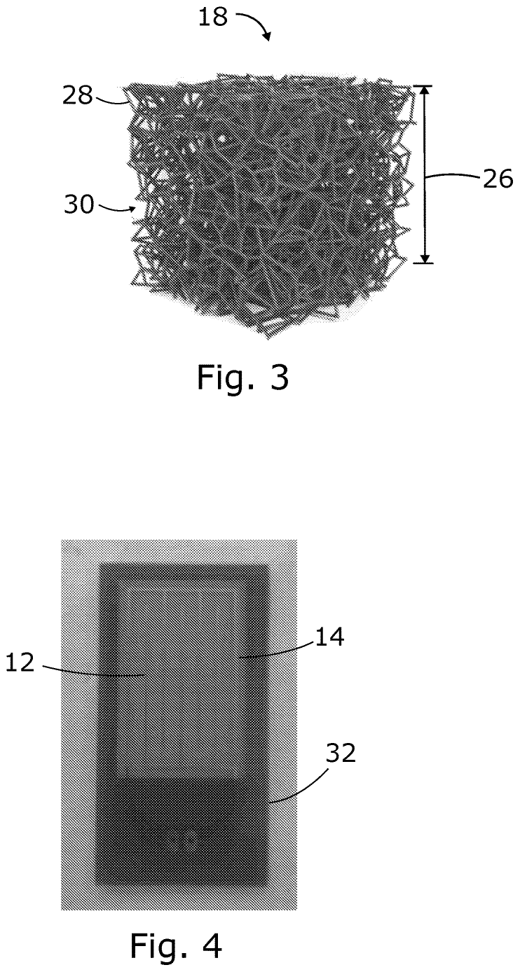

In one embodiment, the polysiloxane base polymer is used in the aforementioned sensor film. 3D conductive microstructure of chemically connected carbon nanofilaments are commercially obtained from CarbonX and uniformly dispersed in the polysiloxane polymer to manufacture a sensor film. FIG. 3 shows an embodiment of a particle 18 having a 3D locally crystalline carbon structure obtained from CarbonX. The CarbonX® grade used was CarbonX1™. In this exemplary structure, having filaments 28 and pores 30, the crystallite size is 1.7×2.5 nm, the pore size is 20-70 nm, the filament thickness is 20-70 nm with a span of 0.75, the filament length is 100-500 nm with a span of 2.00. The aggregate size indicated by span 26 is 1 μm. In an example, the specific surface area of the particle 18 (measured using N₂ absorption) is 108 m²/g. A specific surface area of at least 100 m²/g is preferred in some embodiments.

In another embodiment, the polysiloxane base polymer, 3D conductive microstructure of chemically connected carbon nanofilaments and SnO₂ nanoparticles are uniformly dispersed in the polysiloxane polymer to manufacture a sensor film.

The following compositions as examples of presented invention were developed and tested:

TABLE 1
Compositions Tested

| | |
|---|---|
| Composition A | Polysiloxane + 15% CarbonX1 |
| Composition B | Polysiloxane + 15% CarbonX1 + 15% SnO₂ |
| Composition C | Polysiloxane + 5% CarbonX1 |

As with loose CNTs or GNPs as disclosed in U.S. Pat. No. 11,143,610, the CNT microstructures disclosed here may form connections to form paths for electrical conduction through the polymer. However, due to the much smaller aspect ratios of the CNT microstructures as compared to loose CNTs or GNPs, a much greater quantity of CNT microstructure is needed to obtain similar resistance effects. For example, the 15% CNT structure compositions disclosed here still have high electrical resistance as compared to a loose mix of 3% CNTs and 1% GNPs.

These tested compositions do not include dispersed carbon nanomaterials, where the nanomaterials do not include a chemically bonded 3D structure. However, optionally such dispersed carbon nanomaterials, such as graphene nanoplatelets or multiwalled carbon nanotubes, could be added to the composition. Such a combination of particles may reduce temperature dependence. While combinations of dispersed nanostructures with 3D structures are contemplated, such mixtures pose challenges with simultaneous dispersion of both types of particles.

A disadvantage of the microstructures is that they lose conductivity at elevated temperatures. Performance is considered good up to about 50° C., but the coating increases in resistance by about 80% as temperature rises up to 130° C., and at 170° C. the loss of conductivity is considered too great to be usable. Loose CNTs by contrast work up to degradation of the polysiloxane matrix which can be as high as 275° C.

The chemically connected microstructures may be better able to be dispersed within the polymer than loose nanostructures such as CNTs. The use of a solvent can mitigate this issue for nanostructures such as CNTs.

FIG. 8 is a graph showing % increase in resistance (relative to room temperature) vs temperature of a Composition A coating.

It is believed, though not tested, that other types of particles having a 3D chemically connected carbon structure and having specific surface area comparable to the tested CNT microstructures, for example at least 100 m²/g, may also be beneficially used in place of the CNT microstructures. Some carbon black particles, for example, may have these properties. However, crystalline carbon black particles have been found to lead to brittleness of the material when added to the polymer in sufficient quantities to provide suitable electrical properties (typically 13% or 14%), and amorphous carbon black particles have been found to have worse electrical properties. However, carbon black with crystalline microstructure and small pore size but large total pore area (e.g. at least 100 m²/g measured by N₂ absorption) may work.

Optionally, the particles having 3D chemical connected carbon structure, the dispersed carbon nanomaterials (if present) or both may have functional groups on their surfaces.

The SnO₂ has a higher resistance than the microstructures which is believed to cause an increase in overall resistance of the coating for composition B as recorded below.

In the tested composition B, the metal oxide nano-particles are dispersed in the polymer in addition to the CNT microstructures. It would also be possible to include such particles in the particles having 3D chemically connected carbon structures, for example CNT microstructures.

Sensing elements may be constructed by incorporating electrodes into a composition, for example as described above. Each sensing element may have a positive electrode and a passive electrode, the passive electrode being connected to ground. The sensor system may also comprise a data acquisition system in communication with the positive electrode of each sensing element, for receiving electrical signals from the one or more sensing elements.

As disclosed in U.S. Pat. No. 11,143,610, the sensors may be included in a sheet of flexible material which may be applied to a surface, for example a surface of a transportation or storage structure.

Each sensor may measure an electrical property, for example resistance, through a circuit that extends through the composition between the electrodes. A leak may be detected based on a change in resistance. The resistance may depend on the presence of a leaking fluid, but may also depend on other stimuli, for example temperature. The temperature profile showing % resistance change with respect to temperature from RT to 160° C. of the sensor is shown in FIG. 8. The resistance change due to other stimuli such as temperature may be compensated for using sensors for these stimuli or using multiple sensors with different relative sensitivity to the stimulus detected and the other stimuli.

A sensing system may include one or more sensors connected to a data acquisition system. The sensing system may be calibrated to compensate for temperature or other additional stimuli for example by including and comparing sensors with different responses to the additional stimulus, or by comparing to direct measurements of the additional stimulus obtained with one or more additional sensors. Optionally, an ANFIS algorithm may be used as described in U.S. Pat. No. 11,143,610, with or without calibration using different or additional sensors.

The disclosed sensors may measure resistance, or other electrical properties, in various directions. A sensor measures an electrical property in a direction from one electrode to another electrode of the sensor. Where electrodes have complex shapes, a single sensor may measure resistance in multiple directions. In the case of coplanar electrodes, for example included at the same depth within a sheet of flexible material, the electrical property is measured in directions parallel to the surface defined by the electrodes but not perpendicular to that surface. Resistance (or another electrical property) may be measured in the thickness direction using electrodes that are displaced from each other in the thickness direction, for example crossing each other.

As described in U.S. Pat. No. 11,143,610, a polymer with embedded particles may be applied to a surface by spray coating. In an embodiment, a sensing surface may be formed by applying the spray coating to a flexible circuit board including traces to form the electrodes, or electrodes may be applied using conductive ink. Optionally, some or all of the data acquisition system could be included on the circuit board if present. As described in U.S. Pat. No. 11,143,610, large areas of the sensing surface may be produced for example in a roll-to-roll process and wrapped around a structure, or small areas may be adhered to the structure.

Where an overall conductivity change occurs due to conductivity change of the embedded particles, the polymer may be used simply as a binder, so it is not necessary for the polymer itself to have properties varying in response to exposure to hydrocarbons. However, polymers that do alter properties in response to such exposure, as disclosed in U.S. Pat. No. 11,143,610, may increase sensitivity. Polysiloxane or a polysiloxane copolymer, which are silicone-based polymers, are examples. Other polymers that may be used include (i) synthetic rubber, (ii) polyvinyl chloride, (iii) polymethacrylate, (iv) other silicone-based polymers; and (v) thermoplastic polymer.

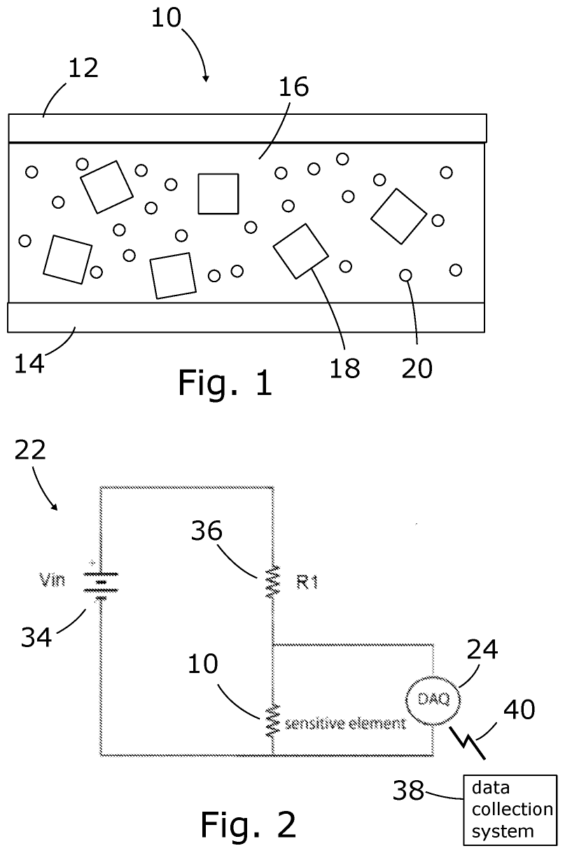

FIG. 1 is a schematic diagram showing a configuration (not to scale) using a composition including both carbon microstructures and SnO₂ particles. In the configuration shown, a sensor element 10 includes a polymer 16 with particles 18 including 3D carbon structure and SnO₂ particles 20 embedded in the polymer. The polymer lies between a first electrode 12 and a second electrode 14, arranged to measure an electrical property such as resistance. In typical embodiments the particles would be much smaller in relation to the distance between electrodes than shown. In the version shown in FIG. 1, polymer is shown only between the electrodes, but it may also extend beyond. For example, polymer may be deposited on top of interleaved electrodes. The SnO₂ particles are also shown here larger in relation to the carbon microstructures than was the case in the embodiments tested. In a tested embodiment, the SnO₂ particles were less than 100 nm in size, with most having diameters in between 10 nm and 70 nm. They were spherical in shape as shown in FIG. 1.

As disclosed in U.S. Pat. No. 11,143,610, a sensor system 22 may include a data acquisition system 24 (labeled as DAQ in FIG. 2) to collect information from the sensor element 10. FIG. 2 shows an example using a voltage drop method. In this example, a current-limiting resistor 36 is placed in series with each sensor element. A person skilled in the art can select a suitable range of resistances based on the resistance of the sensor elements. Example resistances include 47 kΩ and 1 MΩ. Different resistances may be applied in series with different sensor elements to enable analog tagging as described below. A voltage source 34 may have a variety of voltages. In many uses of a hydrocarbon gas sensor the source would be required to have low enough voltage so as to not risk igniting the hydrocarbon gas with a spark. In an example, a voltage of 1.8V is supplied. The DAQ may be connected to a further data collection system 38 by any suitable means, including wired or wireless. A wireless connection 40, which may use for example Bluetooth®, is shown.

### Configuration 1:25×15 mm Rectangular Sensors.

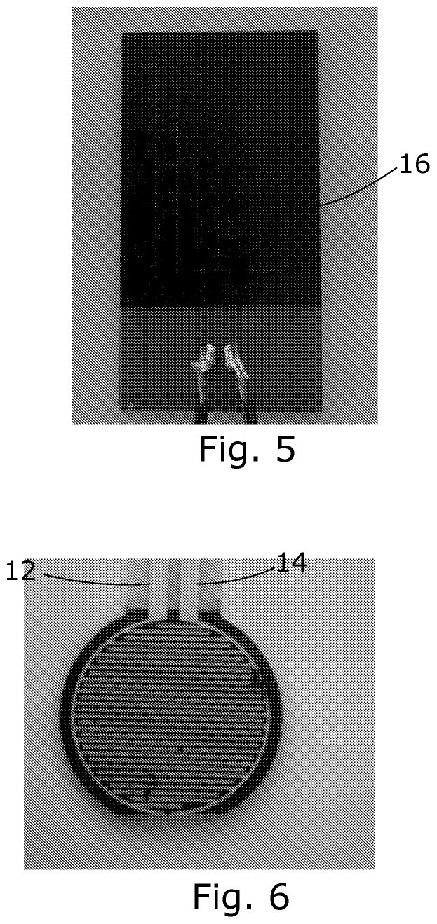

FIG. 4 shows an uncoated sensor substrate used for exemplary rectangular sensors. FIG. 4 shows an uncoated 25×15 mm rectangular sensor substrate. FIG. 5 shows a coated 25×15 mm rectangular sensor formed by application of a sensor coating composition to the substrate of FIG. 4. Composition A and B sensors were fabricated in this configuration. As shown in FIG. 4, the substrate 32 may have electrodes present before the sensor coating is applied to form the sensor elements. In the embodiment shown, first electrode 12 and second electrode 14 are interleaved. The substrate shown was obtained commercially with electrodes pre-applied and the particular arrangement of the electrodes shown does not form part of the invention.

### Configuration 2:10 mm Circular Sensors.

FIG. 6 shows a back of a coated 10 mm circular sensor showing an interleaved electrode pattern. Dark spots visible in this figure are believed to be specks of coating that came around the sensor when sprayed on the front. The substrate shown was obtained commercially with electrodes pre-applied and the particular arrangement of the electrodes shown does not form part of the invention.

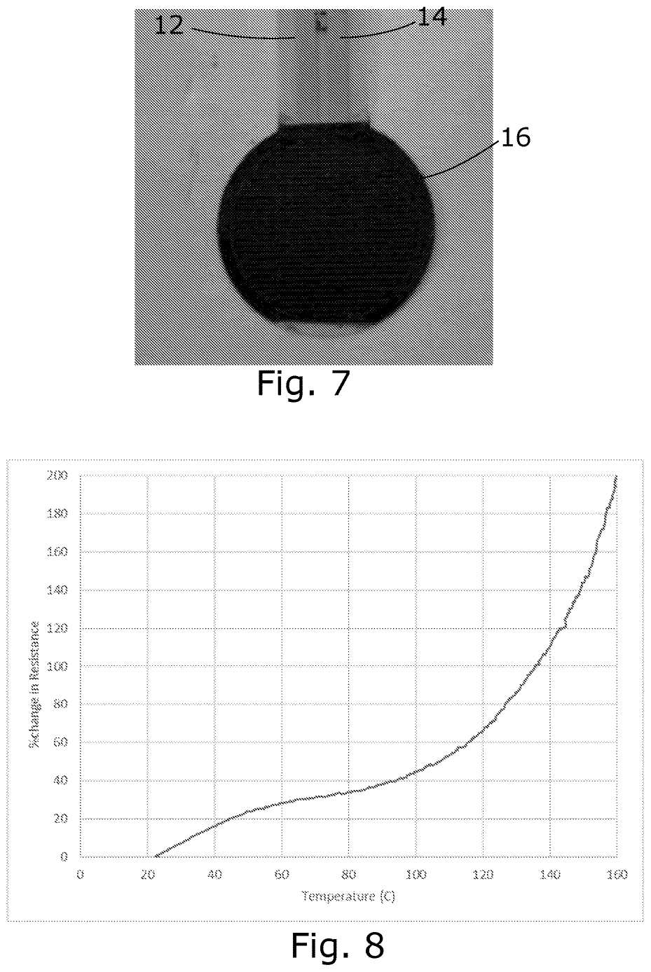

FIG. 7 shows a front of a coated 10 mm circular sensor. Composition C sensors were fabricated in this configuration.

Compositions A, B and C are tested with various gases and liquids to determine their response to exposed chemicals. The response mechanism is adsorption by the carbon materials or absorption by the polymer of the fluid which gives an increase in electrical resistance of the sensor material, thus any increase in electrical resistance in response to leaked chemical is recorded.

For the gas testing the sensors were exposed to a gas stream at 0.5 l./min flow rate.

For the liquid tests 0.02 ml of liquid was dropped onto the middle of the sensor.

Each test was applied to a different sensor, the sensors of each composition type taken from a single batch of coating and sensor substrate. However, there were some variations in initial resistance due to variation in sprayed thickness and less than perfect mixing. Accordingly, the initial resistance is also measured and taken into account in the tests. The same techniques could be applied in regular use to mitigate manufacturing variability.

TABLE 2
Gas Test Results for 25 × 15 mm rectangular sensors

| | | Initial | Max. % | Time to Max |
|---|---|---|---|---|
| | | Resistance | Resistance | Resistance |
| Gas | Composition | Kohm | Increase | Change (sec) |
| Primus Prime | Composition A | 13 | 37% | 11 |
| Gas | Composition B | 121 | 52% | 10 |
| Propane/Butane | | | | |
| Mix | | | | |
| 1% NH₃ | Composition A | 13 | 0.9% | 120 |
| | Composition B | 70 | 0.2% | 60 |
| 5% CO₂ | Composition A | 15 | 0% | — |
| | Composition B | 127 | 0% | — |
| 2.5% Methane | Composition A | 13.7 | 0% | — |
| (50% LEL) | Composition B | 100 | 0% | — |

Both Composition A and B responded well to propane/butane gas mixture, and both gave a response to the Ammonia gas but neither responded to the CO₂ or methane gas mixtures.

TABLE 3
Liquid Exposure tests (0.02 ml liquid)
on 25 × 15 mm rectangular sensors

| | | Initial | Resistance |
|---|---|---|---|
| | | Resistance | Increase after 60 |
| | | Kohm | seconds exposure |
| Diesel | Composition A | 13 | 27% |
| | Composition B | 52 | 17% |
| Cyclopentane | Composition A | 8 | 55% |
| | Composition B | 134 | 48% |
| Light Paraffin Oil | Composition A | 8 | 14% |
| | Composition B | 106 | 15% |

Both compositions were able to detect a minute amount of Diesel, Cyclopentane and Light Paraffin Oil.

TABLE 4
Gas exposure Testing with 10 mm circular sensors

| | | | | Response time |
|---|---|---|---|---|
| | | Initial | Max. % | to Max |
| | | Resistance | Resistance | Resistance |
| Gas | Composition | Ohm | change | Change (sec) |
| 1000 PPM | Composition C - | 255 | 6% | 11 |
| Butane | Surface abraded | | | |
| | Composition C - No | 328 | 2% | 35 |
| | surface treatment | | | |

FIGS. 6 and 7 show the layout of the circular sensor used for these tests.

Both sensors detected 1000 ppm Butane, the sensor which had its surface abraded prior to exposure to the gas gave a much higher response.

The sensors disclosed in this document may be sampled repeatedly over time to obtain a response graph. This enables the sensor system to differentiate between different species of leaking fluids including different hydrocarbon gases.

As disclosed in U.S. Pat. No. 11,143,610, each sensing element may have a resistor in series with the element as a current limiting resistance. In an example, each current limiting resistance is different so that each sensing element has a unique representative voltage. A data acquisition system may switch repeatedly between different sensing elements, sequentially interrogating along a chain of sensors so each reading corresponds to a different sensor location. This switching may use for example a microcontroller clock controlling a multiplexer microswitch. The different sensing elements may be located by the different voltage (analog tagging). In an example, there are 50 sensors switched between in this way, though more or fewer may be used. The multiplexed signals may later be de-multiplexed, and the de-multiplexed signals may be processed for example using an ANFIS algorithm as disclosed in U.S. Pat. No. 11,143,610.

The temperature operating range has been established, the sensor containing the 3D carbon structure can be used up to the temperature at which the material exhibits physical changes that significantly affect the coating's resistance, in the case of CarbonX® containing materials the limit is 140° C. (FIG. 8). Above 180° C. it shows evidence of complete breakdown of the structure and irreversible changes in resistance. This is a crucial difference from CNT based coatings previously disclosed that can have a much higher operating temperature, over 200° C.

In order to provide multiple sensing points a Bluetooth® array of sensors may be deployed wherein each sensor has a Bluetooth® transmitter which sends sensor readings that are collected by a Gateway IOT. This is an example of a further data collection system 38 as shown in FIG. 2. The Gateway IOT can read multiple sensors as long as they are in range, typically up to 500 m from the device.

Immaterial modifications may be made to the embodiments described here without departing from what is covered by the claims.

In the claims, the word “comprising” is used in its inclusive sense and does not exclude other elements being present. The indefinite articles “a” and “an” before a claim feature do not exclude more than one of the features being present. Each one of the individual features described here may be used in one or more embodiments and is not, by virtue only of being described here, to be construed as essential to all embodiments as defined by the claims.

1. A sensor for monitoring fluid leakage in a transportation or storage structure, the sensor comprising a data acquisition system in communication with electrodes connected to measure an electrical property of a composition, the composition comprising: a polymer; and, embedded within the polymer, conductive or semi conductive carbon particles having a chemically connected 3D structure and having a specific surface area (N₂ absorption) of at least 100 m²/g.

2. The sensor of claim 1 where the composition does not include dispersed carbon nanomaterials.

3. The sensor of claim 1 where the composition includes dispersed carbon nanomaterials in addition to the particles having 3D carbon structures.

4. The sensor of claim 3 where one or both of the particles having 3D carbon structures and the dispersed carbon nanomaterials have surfaces having functional groups.

5. The sensor of any one of claims 1-3 where the particles having 3D carbon structures have surfaces having functional groups.

6. The sensor of any one of claims 1-5 further comprising semiconductive metal oxide nanoparticles, either included in the particles having 3D carbon structures or separately dispersed within the polymer.

7. The sensor of claim 6 in which the semiconductive metal oxide nanoparticles comprise Iron Oxide, Tin Oxide, or Zinc Oxide.

8. The sensor of any one of claims 1-7 wherein the polymer is one or more of: (i) synthetic rubber, (ii) polyvinyl chloride, (iii) polymethacrylate, (iv) silicone-based polymer; and (v) thermoplastic polymer.

9. The sensor of claim 8 wherein the polymer is a polysiloxane copolymer and the sensor is for monitoring leakage of a hydrocarbon fluid.

10. The sensor of claim 8 wherein the polymer is a polysiloxane copolymer, and the conductive and/or semi conductive particles having 3D carbon structures are locally crystalline Carbon nanotube networks.

11. The sensor of any one of claims 1-10 wherein the 3D carbon structures comprise locally crystalline conductive or semi conductive microstructures comprising networks of chemically connected one or a combination of: (i) Carbon Nanotubes, (ii) Carbon Nanofibers, (iii) Carbon nanofilaments, and (iv) Graphene platelets.

12. The sensor of any one of claims 1-10 wherein the 3D carbon structures are 3D nanostructure graphene sponges, Carbon Black or Carbon fibers.

13. A sensor system for monitoring leakage in a transportation or storage structure, the sensor system comprising one or more sensing elements, each sensing element comprising a polymer and particles comprising 3D carbon structures of chemically connected carbon and having a surface area (as measured by N₂ absorption) of at least 100 m²/g embedded in the polymer, and each sensing element having a positive electrode and a passive electrode, the passive electrode being connected to ground; and the sensor system further comprising a data acquisition system in communication with the positive electrode of each sensing element, for receiving electrical signals from the one or more sensing elements.

14. The sensor system of claim 13 in which the polymer is arranged as a sheet having a thickness direction, the sensor system including a sensing element which measures an electrical property in the thickness direction in addition to one which measures the electrical property parallel to the sheet.

15. The sensor system of claim 13 or claim 14 wherein the polymer is a polysiloxane.

16. The sensor system of any one of claims 13-15 wherein the electrodes comprise one or more of: silver, copper, gold, and platinum.

17. The sensor system of any one of claims 13-16 wherein the one or more sensing element is apply-able directly on to at least a portion of the transportation or storage structure.

18. The sensor system of any one of claims 13-16 further comprising a substrate and wherein the one or more sensing element is disposed on to the substrate, and the substrate is installable on at least a portion of the hydrocarbon transportation or storage structure.

19. The sensor system of any one of claims 13-18 wherein the substrate comprises one or more of: polyimide, polyethylene terephthalate (PET), polycarbonate (PC), and fluorene polyester polyimide, PEEK.

20. The system of any one of claims 13-19 wherein the current limiting resistance is varied across the one or more sensing elements to provide a unique representative voltage to at least one of the one or more sensing elements.

21. The system of claim 20 wherein an analog electrode tagging process is used to locate the at least one sensing element.

22. The system of any one of claims 13-21 in which the data acquisition system comprises a multiplexer microswitch which switches between electrodes of different sensing elements.

23. The system of claim 22 wherein the multiplexer microswitch is controlled by a microcontroller clock establishing a frequency for the switching from one electrode to another.

24. The system of any one of claims 13-19 where each sensor module has a wireless communication circuit which is aggregated in a gateway IOT which sends data from all attached sensors to a cloud-based database.

25. The system of any one of claims 13-24 wherein the system is calibrated to take into account temperature effects on the sensor network.
